(19) United States
(12) Patent Application Publication
(10) Pub. No.: US 2019/0257348 A1
(43) Pub. Date: Aug. 22, 2019

(54) STAY TIGHT FASTENERS

(71) Applicant: Albert Tamer, San Francisco, CA (US)

(72) Inventor: Albert Tamer, San Francisco, CA (US)

(21) Appl. No.: 15/899,931

(22) Filed: Feb. 20, 2018

(51) Int. Cl. F16B 39/08

(52) U.S. Cl. CPC F16B 39/08

(57) ABSTRACT

Improved mechanical fasteners, such as improved bolts and screws, are disclosed. The mechanical fasteners include a shaft portion configured to be disposed into a substrate; a head portion located at a top side of the shaft portion; and a means for securing the head portion to a substrate (and/or surrounding surfaces). The means for securing the head portion to the substrate is configured to operate independent of the shaft portion and independent of a nut used in connection with the fastener. The means for securing the head portion to the substrate may include restraining caps, channel and pin combinations, spring-loaded wedges, malleable staples, nestable wedges, and other components that are configured to secure the head portion of the fastener to the substrate (and to prevent unwanted rotation and loosening of the fastener from the substrate).

### FIELD OF THE INVENTION

The field of the present invention relates to various types of mechanical fasteners and, more particularly, the field of the invention relates to certain mechanical fasteners (such as screws, bolts, nails, and the like), which are configured to prevent unwanted loosening.

### BACKGROUND OF THE INVENTION

Previous efforts at preventing the unwanted loosening of screws, bolts, and other mechanical fasteners have focused on modifying, for example, the threads of the shafts of such fasteners in a way that a tight connection with an underlying substrate is encouraged. In other cases, such efforts have involved various mechanical arrangements to connect a nut to the threads (or to the shank of a bolt or machine screw)—and still other efforts have involved the use of protrusions (e.g., on the shank of a bolt) that are configured to “dig” into a substrate to prevent unwanted loosening (i.e., backward rotation of the fastener).

Although such methods have provided some modicum of improvement, such currently-available methods often still exhibit an unacceptable failure rate and/or are otherwise difficult (and expensive) to manufacture. In addition, there are some circumstances—such as those involving the use of wood screws, sheet metal screws, and bolts fastened into threaded housings—where it is either costly or not possible to utilize certain currently-available methods (e.g., connecting a nut to the shank of a bolt). Accordingly, a continued need exists for improved mechanical fasteners that are configured to prevent unwanted loosening.

As the following will demonstrate, the present invention addresses such demands in the marketplace and provides many benefits that are not observed with currently-available fasteners.

### SUMMARY OF THE INVENTION

According to certain aspects of the present invention, improved mechanical fasteners are provided, such as improved nuts, bolts and screws. The improved mechanical fasteners are preferably configured to secure the nut (if applicable) and the head portion of the fastener to the surface of a substrate, after the fasteners have been tightened to the desired tension, such that unwanted rotation of the nut and/or head portion (and loosening of the fastener from the substrate) is prevented. According to such aspects of the invention, the mechanical fasteners include a shaft portion configured to be disposed into a substrate; a head portion located at a top side of the shaft portion; and a means for securing the head portion to the surrounding substrate. Importantly, the invention provides that the means for securing the head portion to the substrate is configured to operate independent of the shaft portion (and, furthermore, independent of a nut used in connection with the fastener). As described further below, the means for securing the head portion to the substrate may include restraining caps, channel and pin combinations, spring-loaded wedges, malleable staples, and other components that are configured to secure the head portion of the fastener to the substrate (and to prevent unwanted rotation and loosening of the fastener from the substrate). In certain embodiments, the invention provides that the nut portion of a fastener may also be improved by securing the nut portion to a substrate using the methods and devices described herein.

The above-mentioned and additional features of the present invention are further illustrated in the Detailed Description contained herein.

### BRIEF DESCRIPTION OF THE FIGURES

FIG. 1 is a perspective view of the restraining cap described herein.

FIG. 2 is a perspective view of the braced restraining cap described herein, which includes a series of diagonal stiffeners that are configured to rest adjacent to a top side of the head portion of the fastener.

FIG. 3 is a perspective view of the restraining cap of FIG. 1 fitted over/nestably inserted on top of the head portion of a fastener (a bolt), which further shows a screw disposed in the aperture of the appendage of the restraining cap (to secure the restraining cap to the substrate, to prevent rotation of the bolt head, as described herein).

FIG. 4 is a perspective view of the braced restraining cap of FIG. 2 fitted over/nestably inserted on top of the head portion of a fastener (a bolt), which further shows a screw disposed in the aperture of the appendage of the restraining cap.

FIG. 5 is a perspective view of two restraining caps of FIG. 1, with a first restraining cap being nested over the bolt head portion of the fastened connection, and a second restraining cap being nested over the nut portion of the fastened connection.

FIG. 6 is a perspective view of a bolt with a modified head having a staple positioned in an elongated engaged position, and a nut modified to have a staple positioned in a folded disengaged position (for ease of viewing, the substrates being fastened together are not shown).

FIG. 7 is a perspective view of a fastener (a screw, e.g., a wood screw, a plastic screw, or a sheet metal screw), having a staple positioned in a folded disengaged position and within a window located within the head of the fastener so that the screw is configured to be fastened in and out of any substrate, without the staple interfering.

FIG. 8 is a perspective view of a fastener (a screw, e.g., a wood screw, a plastic screw, or a sheet metal screw), having a staple positioned in an elongated engaged position and originating from within a window located on a bottom surface of the head portion.

FIG. 9 is a side view of a fastener (a screw, e.g., a wood screw, a plastic screw, or a sheet metal screw), having a staple positioned in a folded disengaged position and within a window located within the head of the fastener so that the screw is configured to be fastened in and out of any substrate, without the staple interfering.

FIG. 10 is a side view of a fastener (a screw, e.g., a wood screw, a plastic screw, or a sheet metal screw), having a staple positioned in an elongated engaged position and originating from within a window located on a bottom surface of the head portion.

FIG. 11 is a perspective view of a fastener (a screw, e.g., a wood screw, a plastic screw, or a sheet metal screw) with a cutout of the substrate material, having a staple positioned in a folded disengaged position and within a window located within the head of the fastener so that the screw is configured to be fastened in and out of any substrate, without the staple interfering.

FIG. 12 is a perspective view of a fastener (a screw, e.g., a wood screw, a plastic screw, or a sheet metal screw) with a cutout of the substrate material, having a staple positioned in an elongated engaged position and originating from within a window located on a bottom surface of the head portion.

FIG. 13 is another perspective view of the fastener (a screw, e.g., a wood screw, a plastic screw, or a sheet metal screw) of FIG. 11, disposed into a substrate material, having a staple positioned in a folded disengaged position and within a window located on a bottom surface of the head portion so that the screw is configured to be fastened in and out of the substrate, without the staple interfering.

FIG. 14 is another perspective view of the fastener (a screw, e.g., a wood screw, a plastic screw, or a sheet metal screw) of FIG. 12, disposed into a substrate material, having a staple positioned in an elongated engaged position and originating from within a window located on a bottom surface of the head portion.

FIG. 15 is a top side, perspective view of a fastener (a wood screw) and staple described herein, with the staple having a pair of stop wings as described herein.

FIG. 16 is a top side view of a fastener (a screw, e.g., a wood screw, a plastic screw, or a sheet metal screw) having a series of channels positioned within a recessed slot accessible from the top surface of the head portion.

FIG. 17 is a side view of the fastener of FIG. 16, showing a pin inserted through one of the channels.

FIG. 18 is a perspective view of the spring-loaded wedge described herein, with the hinged surface thereof making contact with the pole of the wedge.

FIG. 19 is a perspective view of the spring-loaded wedge of FIG. 18, with the hinged surface rotated away from the pole of the wedge.

FIG. 20 is a perspective view of the spring-loaded wedge of FIG. 18, with the hinged surface making contact with the pole of the wedge and making further contact with a side surface of the head portion of the fastener (to prevent rotation of the head portion in a loosening direction).

FIG. 21 is a perspective view of the spring-loaded wedge of FIG. 18, with the hinged surface rotated away from the pole of the wedge, which is shown to be caused by rotation of the head portion in a direction that will tighten the fastener to a substrate (with such rotation being executed by the socket wrench shown therein).

FIG. 22 is a side view of a fastener (bolt) described herein, having a channel positioned within a side surface of the head portion, with the channel having a pin disposed therein that connects and immobilizes the top portion of the fastener to a surrounding material.

FIG. 23 is a perspective view of a fastener (bolt) described herein, having a wedge that is anchored to a surface of the substrate, which is configured to be nestably inserted into one of a plurality of equally-dimensioned windows located along a perimeter of a side surface of the head portion.

FIG. 24 is a perspective view of a fastener (bolt), having a top surface that is adapted to receive a screwdriver, which includes an anchor that connects and immobilizes the top portion of the fastener to the surrounding material (substrate).

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments of the present invention, improved mechanical fasteners are provided, which are preferably configured to prevent unwanted loosening of connections made between such fasteners and a substrate (i.e., the objects and/or materials that are connected to each other using the mechanical fasteners of the present invention). The present specification will use the term “bolt” to describe certain fasteners of the present invention. Unless otherwise specifically stated herein, the term “bolt” should be understood to include not only bolts, but also screws and other male/female threaded elements that are configured to be connected to each other. In addition, although the present specification alludes to the ability of the fasteners of the present invention to prevent unwanted loosening, it should further be understood that many of the embodiments described herein (albeit not all) will further be useful to prevent unwanted tightening of a fastener (i.e., to prevent unwanted stripping of the threads of a fastener).

As described and exemplified further below, in certain preferred embodiments of the present invention, the mechanical fasteners are configured to constrain the head of the fastener in such a way that it is prevented from rotating (i.e., unwanted loosening or tightening). Importantly, the invention provides that such constraint is exerted on the head of the fastener independent of its shank, threads, nut, or other parts of the male or female fastener. Still further, according to certain preferred embodiments, the invention provides that the fasteners may exhibit one of two general configurations. In a first configuration, a bolt may be tightened into a substrate to the desired tension, whereupon the head of the bolt is aligned or capped with a device that subsequently fixes the position of the head relative to the underlying substrate (so that the head portion can no longer rotate until such device is disengaged). In such embodiments, the device may be further attached to the substrate; or it may be wedged between the head portion of the fastener and substrate. In a second configuration, a spring-loaded device is employed that exerts pressure against the head portion of the fastener, such that (as the head portion is tightened to the desired tension) the spring-loaded device springs out of the way; but, if the head portion attempts to rotate in a loosening direction, the spring-loaded device makes contact with the head portion and prevents it from rotating in such direction. Of course, the fasteners of the present invention may be manufactured from any suitably rigid material, such as wood, plastics, steel, titanium, and/or other metals or alloys.

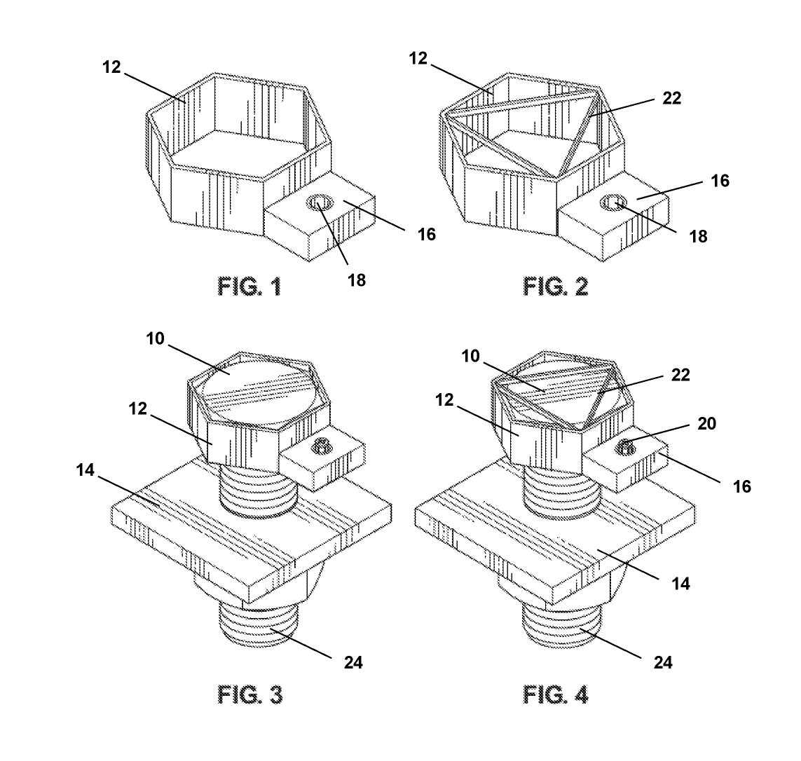

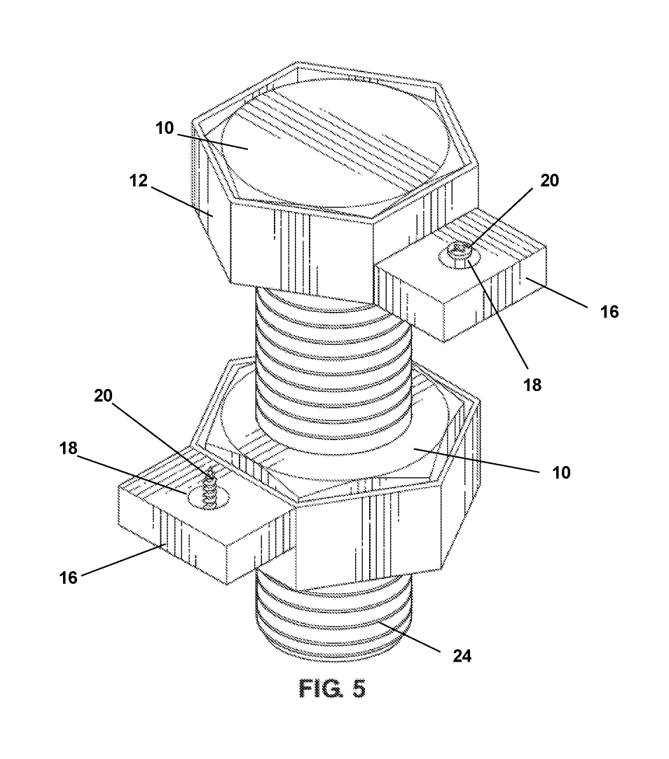

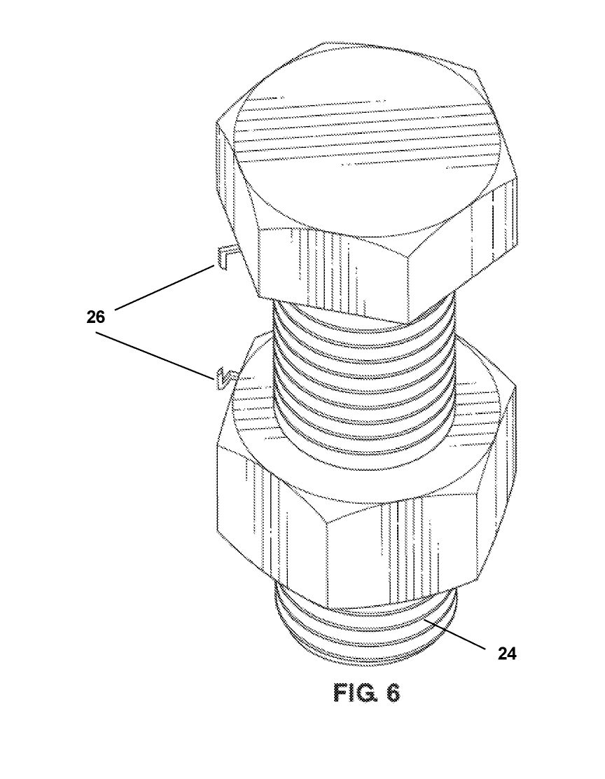

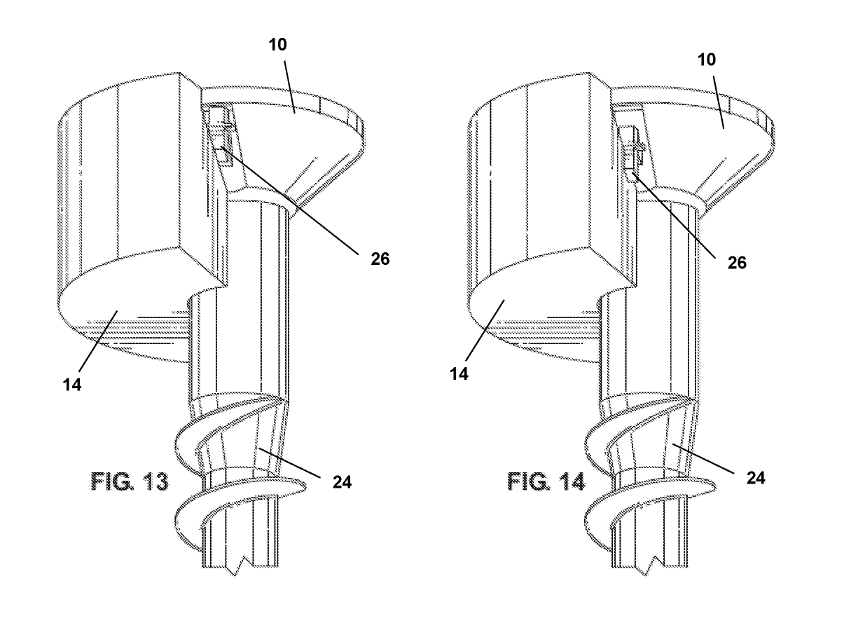

To help illustrate the above configurations, the following will describe, with reference to FIGS. 1-23, several examples and various embodiments of the present invention. In some embodiments that involve the use of a bolt and nut connection, the invention provides that it may be desirable to utilize the methods and devices described herein to tighten and prevent further rotation of the bolt and the nut (e.g., as illustrated in FIGS. 5 and 6).

### EXAMPLES

### Example 1 (Restraining Caps)

Referring now to FIGS. 1-5, in certain preferred embodiments, the fasteners of the present invention may include a head portion 10 and a restraining cap 12. The restraining cap 12 is configured to be nestably inserted over the head portion 10, with the restraining cap 12 being further configured to be subsequently attached to the substrate 14. When the fastener is configured as a bolt (FIGS. 3-5), the invention provides that the restraining cap 12 will preferably include a perimeter comprising a series of connected walls (e.g., six walls), with each wall being oriented to rest adjacent to a corresponding wall along the perimeter of the head portion 10 of the fastener.

In this embodiment, the restraining cap 12 may be attached to the substrate 14 through an appendage 16 that may include, for example, an aperture 18 through which a screw 20 or nail may be inserted and fastened to the substrate 14 (to connect the restraining cap 12 to the substrate 14). Of course, other attachment means, e.g., adhesives, staples, pins, etc., may also be employed to secure the appendage 16 of the restraining cap 12 to the substrate 14. Still further, in certain embodiments, the restraining cap 12 may further include a wall or piece of material, e.g., a series of stiffening braces 22, which resides on a top side thereof, and which is configured to rest adjacent to the top surface of the head portion 10 (FIGS. 2 and 4). The invention provides that when the restraining cap 12 is nestably inserted over the head portion 10, and the appendage 16 of the restraining cap 12 is secured to the substrate 14, the head portion 10 is prohibited from moving and rotating in either direction. Importantly, in this embodiment and the others described herein, the force operating to prevent such rotation exists through the restraining cap 12, which does not involve or require the use of the shaft portion 24 of the fastener and/or a nut used in connection with the fastener.

It is noted that certain fastener connections may employ an immobilized nut within a casing (or, for example, in the case of screws or bolts in a threaded housing, a nut may not be utilized at all). When an immobilized nut is employed, the fastener is still allowed to rotate (e.g., while the fastener is being tightened). In contrast, using the methods and devices described herein, the head portion 10 and/or nut is immobilized after the fastener has been tightened to the desired tension. Importantly, in such fastener connections, using the methods and devices described herein, the head portion 10 of the fastener is prohibited from rotating through a means that does not involve or require the use of the shaft portion 24 of the fastener and/or, if present, a nut used in connection with the fastener.

### Example 2 (Movable Staples)

Referring now to FIGS. 6-15, the mechanical fasteners of the present invention may employ the use of a staple 26 as a means for securing the head portion 10 to a substrate 14. In such embodiments, the staple 26 is positioned on or within the head portion 10 of the fastener. The invention provides that the staple 26 is configured to be manually pushed (or hammered) into the substrate 14, after the fastener has been inserted into and tightened to the substrate 14.

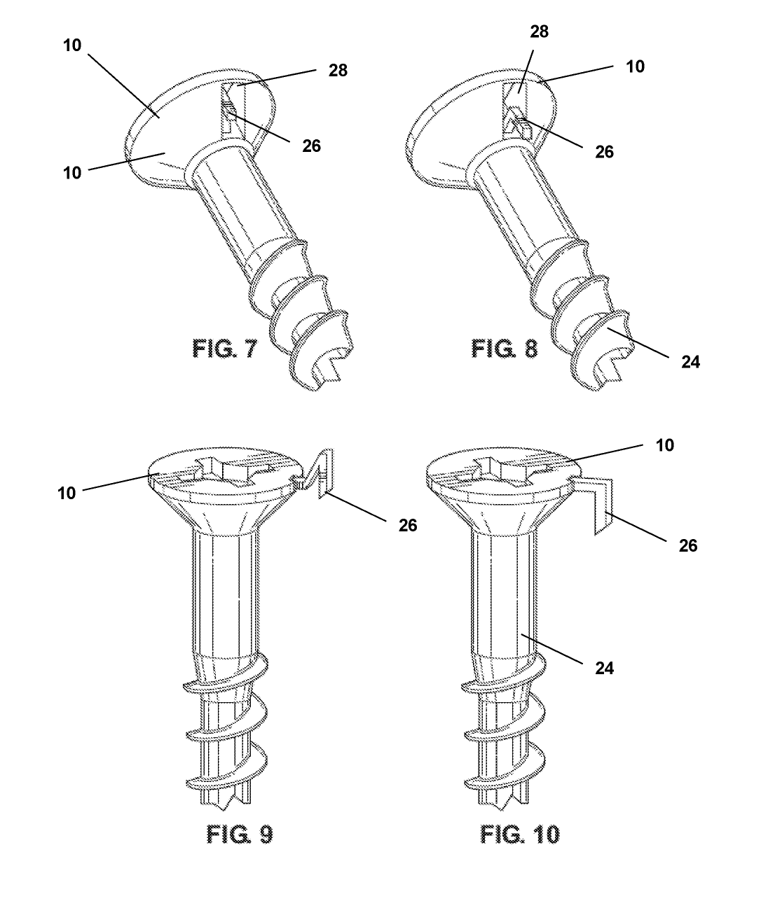

As shown in FIGS. 9 and 10, in certain embodiments, the staple 26 may reside on or near a perimeter of the head portion 10. As shown in FIGS. 7, 8 and 11-15, the staple 26 may also reside within a window 28 through which the staple 26 may be accessed from the top side of the head portion 10, to manually push (or hammer) the staple 26 through the same contiguous window 28 near the bottom surface of the head portion 10. In such embodiments, the staple 26 is preferably comprised of a material (e.g., steel, aluminum, titanium, or other alloys) that is sufficiently malleable to be manually converted from a folded disengaged position (FIGS. 7, 9, 11, and 13) into an elongated engaged position (FIGS. 8, 10, 12, and 14).

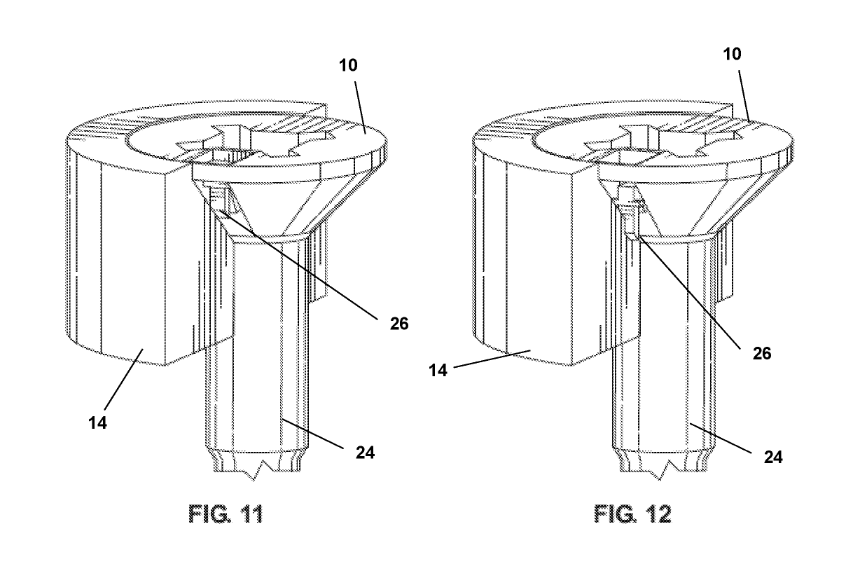

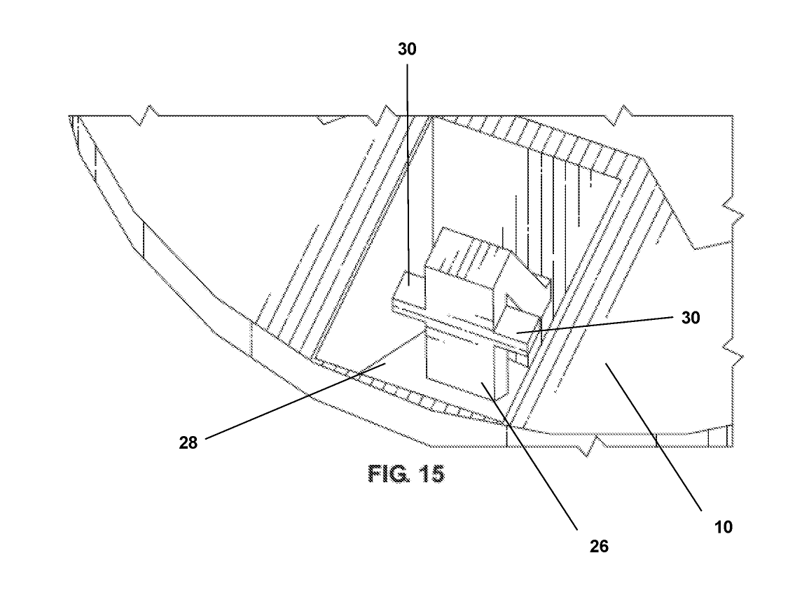

The invention provides that the staple 26 may be manually pushed (or hammered) into a substrate 14 by converting the staple 26 from a folded disengaged position (FIGS. 7, 9, 11, and 13) into an elongated engaged position (FIGS. 8, 10, 12, and 14). Still further, the invention provides that when the staple 26 is pushed into a substrate 14 (after the fastener has been attached to the substrate 14 to the desired tension) by manually converting the staple 26 from a folded disengaged position (FIGS. 7, 9, 11, and 13) into an elongated engaged position (FIGS. 8, 10, 12, and 14), the head portion 10 of the fastener will be prohibited from moving and rotating in either direction (and, as with the embodiments described above, the force operating to prevent such rotation exists through the staple 26 being embedded into the substrate 14, which does not involve or require the use of the shaft portion 24 of the fastener and/or a nut used in connection with the fastener). Referring to FIGS. 11-15, in certain embodiments, the staple 26 may comprise one or more stop wings 30 (FIG. 15) that are positioned and configured to rest adjacent to an exterior surface of the substrate 14, after the staple 26 has been converted to an elongated engaged position and has been inserted into the substrate 14 (FIGS. 12 and 14). The stop wings 30 are configured to limit the extent to which the staple 26 can be pushed into the substrate 14, and to further allow an air gap to be present near the wings 30 where a hook may be inserted to lift (and disengage) the staple 26 out of the substrate 14 (thereby allowing for the purposeful threading out of the screw from the substrate 14).

### Example 3 (Channel/Pin Combinations)

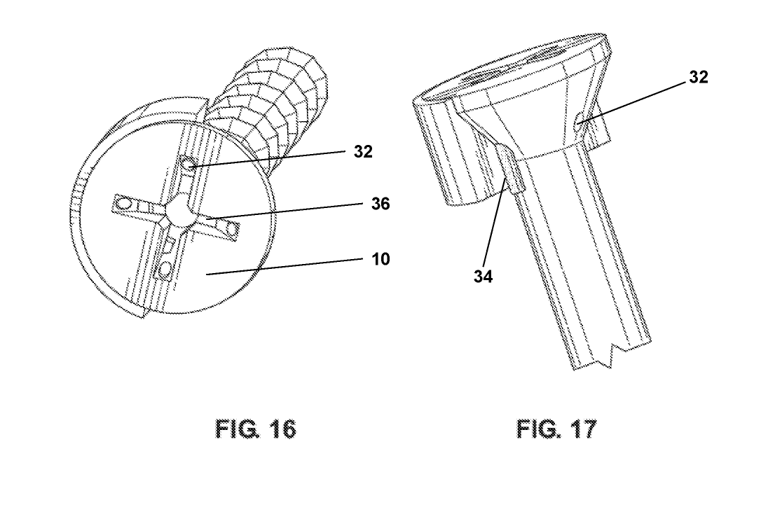

Referring now to FIGS. 16, 17, and 22, the fastener of the present invention may include a means for securing the head portion 10 to a substrate 14 that consists of at least one channel 32 that is configured to receive a pin or nail 34. In certain embodiments, the at least one channel 32 may be positioned within a recessed slot 36 accessible from a top surface of the head portion 10. In such embodiments, the recessed slot 36 may be the same area of the head portion 10 that is configured to receive a screw driver head. In such embodiments, the invention provides that the channel 32 traverses the entire width of the head portion 10 (from top to bottom) and the channel 32 is configured to receive the pin or nail 34, with the pin or nail 34 exhibiting a sufficient length that is configured to be inserted through the channel 32 and into the substrate 14 (FIGS. 16 and 17).

In other embodiments, the channel 32 may be positioned within a side surface of the head portion 10 (FIG. 22). In such embodiments, the channel 32 will traverse the entire width of the head portion 10 (from one side to another), with the channel 32 being configured to receive a pin 34, with the pin 34 being configured to be inserted through the channel 32 and into the substrate 14 or other surrounding material 38 (FIG. 22). Of course, in this example, instead of a pin 34, a nail or other element may be disposed through the channel 32 to secure the head portion 10 to the substrate 14 or surrounding material 38. In addition, as illustrated in FIG. 17, the head portion 10 may include multiple channels 32, each being configured to receive a pin 34 as described herein. The invention provides that after the fastener has been secured to the substrate 14 to the desired tension, the pin 34 may be inserted through a channel 32 to further secure the head portion 10 of the fastener to the substrate 14 or surrounding material 38 (and, as with the embodiments described above, the force operating to prevent such rotation exists through the channel 32 and pin 34 combination, which does not involve or require the use of the shaft portion 24 of the fastener and/or a nut used in connection with the fastener).

### Example 4 (Spring-Loaded Wedges)

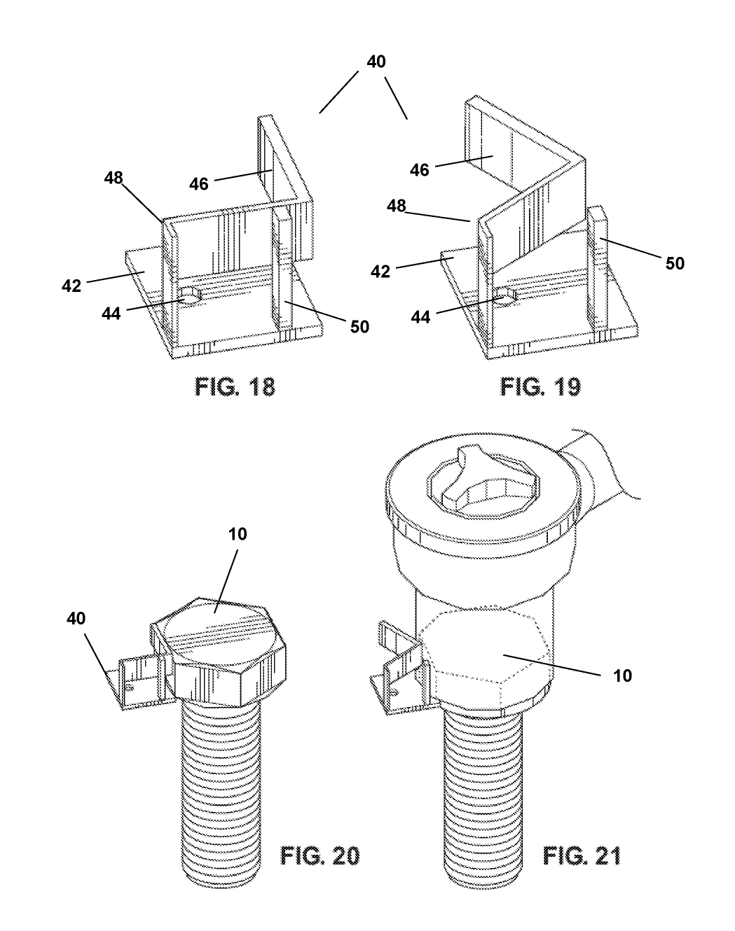

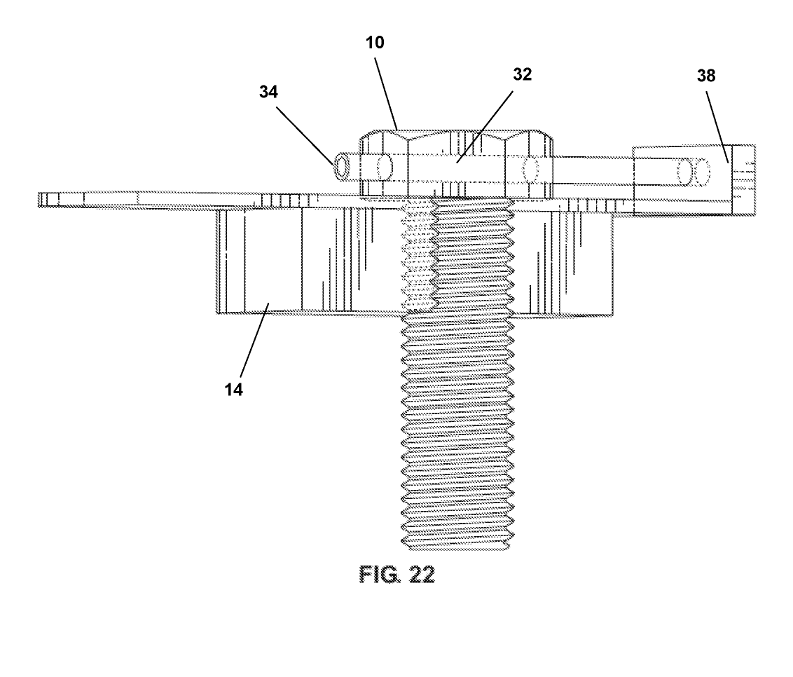

Referring now to FIGS. 18-21, the mechanical fasteners may comprise a spring-loaded wedge 40 for securing the head portion 10 thereof to a substrate 14. In such embodiments, the wedge 40 may include a bottom surface 42 having an aperture 44 that is configured to receive a screw or nail to connect the bottom surface 42 and the spring-loaded wedge 40 to a surface of the substrate 14 (of course, other means for attaching the bottom surface 42 of the wedge 40 to the substrate 14 may be employed, such as nails, adhesives, etc.). The spring-loaded wedge 40 further includes a hinged surface 46 that is configured to rest adjacent to and exert a force on a side surface of the head portion 10 (FIG. 20). More particularly, the hinged surface 46 includes an axis 48 about which the hinged surface 46 is allowed to rotate in a first direction (FIG. 19), but not the other direction. The axis 48 may consist of a spring-loaded mechanism, a material having some memory properties that bias the hinged surface 46 to be positioned in a locked orientation (FIGS. 18 and 20) versus and open orientation (FIGS. 19 and 21), or other means for exerting a bias on the hinged surface 46 in favor of a locked orientation (FIGS. 18 and 20).

According to such embodiments, the wedge 40 will further includes a pole 50 that protrudes upwards and perpendicular from the bottom surface 42 of the spring loaded wedge 40. The invention provides that the pole 50 is preferably positioned and configured to contact the hinged surface 46, when in a closed locked position (FIGS. 18 and 20), to assist the spring-loaded wedge 40 in preventing rotation of the head portion 10 in a direction that would loosen the fastener from the substrate 14. In such embodiments, the invention provides that the hinged surface 46 is further configured to permit rotation of the head portion 10 in a direction that would tighten the fastener to the substrate 14. For example, as illustrated in FIG. 21, when a socket wrench is applied to the head portion 10, the hinged surface 46 allows the wrench to rotate the head portion 10 in a tightening (clockwise) direction, but not in the opposite/loosening/counter-clockwise direction (due to the presence of the pole 50). As with the other embodiments described herein, the spring-loaded wedge 40 is configured to prevent a loosening rotation of the head portion 10 in a manner that does not involve or require the use of the shaft portion 24 of the fastener and/or a nut used in connection with the fastener.

### Example 5 (Nestable Wedges)

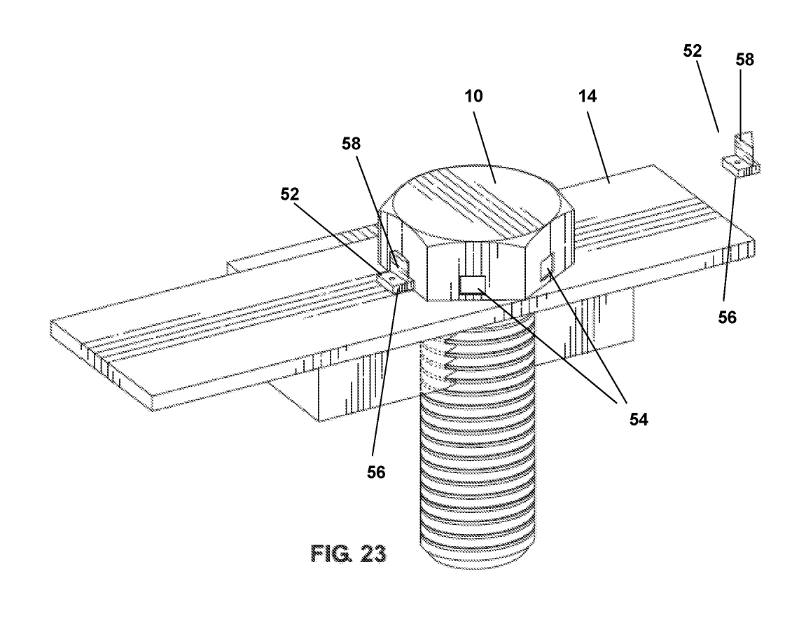

Referring now to FIG. 23, the mechanical fasteners may comprise a nestable wedge 52 that is anchored to a surface of the substrate 14, with the nestable wedge 52 being configured to be nestably inserted into one of a plurality of equally-dimensioned windows 54 located along a perimeter of a side surface of the head portion 10, which is effective to secure the head portion 10 to a substrate 14. More particularly, in such embodiments, the nestable wedge 52 will preferably comprise at least a first surface 56 and a second surface 58, with the first 56 and second 58 surfaces being connected or integrally formed with each other at an adjoined edge, preferably oriented perpendicular to each other.

The invention provides that the first surface 56 is configured to be affixed to the substrate 14, e.g., by disposing a screw, nail, or pin through an aperture located therein (or through adhesives or other appropriate means). The invention further provides that the second surface 58 will preferably have an outer dimension that is configured to be nestably inserted into one of the plurality of equally dimensioned windows 54 located along a perimeter of a side surface of the head portion 10. When the second surface 58 is nestably inserted into one of the plurality of equally dimensioned windows 54, the head portion 10 is prevented from rotating—and, as with the other embodiments described herein, such prevention is achieved in a manner that does not involve or require the use of the shaft portion 24 of the fastener and/or a nut used in connection with the fastener.

### Example 6 (Anchors)

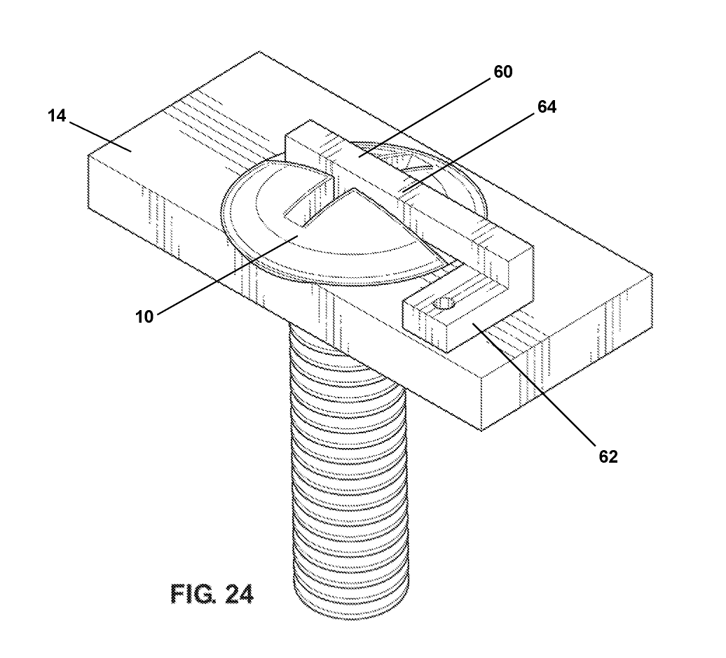

Referring now to FIG. 24, in other embodiments, the mechanical fasteners may comprise an anchor 60 having a first end 62 that is adapted to be connected to a surface of the substrate 14 and a second end 64 exhibiting a dimension that is adapted to be nestably inserted into a recessed area of the top surface of the head portion 10 (which is otherwise adapted to receive a head of a screwdriver). In such embodiments, the anchor 60 is configured to secure the head portion 10 to the substrate 14 and to prevent its further rotation (after the fastener has been connected and tightened to the substrate 14 to the desired tension).

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A mechanical fastener comprising a bolt or screw, wherein the fastener includes (a) a shaft portion configured to be disposed into a substrate; (b) a head portion located at a top side of the shaft portion; and (c) a means for securing the head portion to the substrate or surrounding surfaces, after the fastener has been tightened to a desired tension, wherein said means is configured to (i) operate independent of the shaft portion and independent of a nut used in connection with the fastener and (ii) be disengaged when a user desires to loosen the fastener from the substrate or surrounding surfaces.

2. The mechanical fastener of claim 1, wherein the means for securing the head portion to the substrate comprises a restraining cap that is configured to be nestably inserted on top of the head portion, wherein the restraining cap includes an appendage having an aperture that is configured to receive a screw or nail to connect the appendage and the restraining cap to a surface of the substrate.

3. The mechanical fastener of claim 2, wherein the restraining cap further includes a surface, or one or more bars, which are positioned and configured to rest adjacent to a top side of the head portion.

4. The mechanical fastener of claim 1, wherein the means for securing the head portion to the substrate comprises a staple, wherein the staple (a) is positioned on or within the head portion and (b) is configured to be manually pushed into the substrate, after the fastener has been inserted into and tightened to the substrate.

5. The mechanical fastener of claim 4, wherein the staple (a) is configured to be disposed through an opening located on a bottom surface of the head portion and (b) is comprised of a material that is sufficiently malleable to be manually converted from a folded disengaged position to an elongated engaged position.

6. The mechanical fastener of claim 5, wherein the staple includes one or more wings that are positioned and configured to rest adjacent to an exterior surface of the substrate, after the staple has been converted to an elongated engaged position and has been inserted into the substrate.

7. The mechanical fastener of claim 4, wherein the staple (a) resides on or near a perimeter of the head portion and (b) is comprised of a material that is sufficiently malleable to be manually converted from a folded disengaged position to an elongated engaged position.

8. The mechanical fastener of claim 7, wherein the staple includes one or more wings that are positioned and configured to rest adjacent to an exterior surface of the substrate, after the staple has been converted to an elongated engaged position and has been inserted into the substrate.

9. The mechanical fastener of claim 1, wherein the means for securing the head portion to the substrate comprises at least one channel positioned within the head portion, wherein the channel is configured to receive a pin, wherein the pin is configured to (a) be inserted through the channel and into the substrate and (b) resist further rotation of the head portion.

10. The mechanical fastener of claim 1, wherein the means for securing the head portion to the substrate comprises at least one channel positioned within a side surface of the head portion, wherein the channel is configured to receive a pin, wherein the pin is configured to be inserted through the channel and into the substrate or surrounding surfaces.

11. The mechanical fastener of claim 1, wherein the means for securing the head portion to the substrate comprises a spring-loaded wedge, wherein the spring-loaded wedge:
(a) includes a bottom surface having an aperture that is configured to receive a screw or nail to connect the bottom surface and the spring-loaded wedge to a surface of the substrate;
(b) includes a hinged surface that is configured to rest adjacent to and exert a force on a side surface of the head portion; and
(c) is configured to prevent rotation of the head portion in a direction that would loosen the fastener from the substrate.

12. The mechanical fastener of claim 11, wherein the hinged surface of the spring-loaded wedge is further configured to permit rotation of the head portion in a direction that would tighten the fastener to the substrate.

13. The mechanical fastener of claim 1, wherein the means for securing the head portion to the substrate comprises a wedge that is anchored to a surface of the substrate, wherein the wedge is configured to be nestably inserted into one of a plurality of equally-dimensioned windows located along a perimeter of a side surface of the head portion after the fastener has been connected and tightened to the substrate.
